(19) United States
(12) Patent Application Publication
(10) Pub. No.: US 2019/0020228 A1
(43) Pub. Date: Jan. 17, 2019

(54) STATOR FOR ROTARY ELECTRIC MACHINE, ROTARY ELECTRIC MACHINE, AND METHOD FOR MANUFACTURING STATOR FOR ROTARY ELECTRIC MACHINE

(71) Applicant: MITSUBISHI ELECTRIC CORPORATION, Tokyo (JP)

(72) Inventors: Tatsuro HINO, Tokyo (JP); Kohei EGASHIRA, Tokyo (JP); Yoshihiro HARADA, Tokyo (JP); Shohei MATSUOKA, Tokyo (JP); Masashi NAKAMURA, Tokyo (JP); Shinichiro YOSHIDA, Tokyo (JP); Aiko NAKANO, Tokyo (JP)

(73) Assignee: Mitsubishi Electric Corporation, Tokyo (JP)

(21) Appl. No.: 16/068,205

(22) PCT Filed: Nov. 29, 2016
(86) PCT No.: PCT/JP2016/085408

§ 371 Date: Jul. 5, 2018

(30) Foreign Application Priority Data
Jan. 12, 2016 (JP) 2016-003180

(51) Int. Cl. H02K 1/16; H02K 3/12; H02K 3/48

(52) U.S. Cl. CPC H02K 1/165; H02K 5/1732; H02K 3/48; H02K 3/12

(57) ABSTRACT

A stator for a rotary electric machine includes: a collar portion provided at an end portion of each of the tooth portions so as to project to the slot side and includes: a connection portion; a bent portion extending in the circumferential direction and forming a first gap; and a stop portion projecting at an end side thereof in the circumferential direction to the slot side and formed so as to have a width in the radial direction larger than a width in the radial direction of the bent portion. An R dimension of a side surface, in the circumferential direction and at a side opposite to a projection side of the tooth portion, of the bent portion is not less than the width in the radial direction of the bent portion.

### TECHNICAL FIELD

The present invention relates to a stator for a rotary electric machine, a rotary electric machine, and a method for manufacturing the stator for the rotary electric machine that can inhibit stress concentration and improve fatigue strength.

### BACKGROUND ART

In recent years, rotary electric machines such as electric motors and power generators have been required to have a small size and high output and have high efficiency. An example means for meeting the requirements is to narrow the width of the slot opening of the stator. If the slot opening width is narrowed, the magnetic resistance is reduced, and the efficiency of the rotary electric machine is improved. This allows the rotary electric machine to have a small size and high output. However, there is a problem that if the slot opening width is narrowed, it becomes difficult to mount the coil to the slot.

As a conventional stator that solves such a problem, a stator has been proposed in which: a tooth includes a tooth body portion and a tooth end portion; and after a coil is mounted, the tooth end portion is opened toward a slot side, which is the outer side in the circumferential direction, whereby the slot opening width is narrowed (for example, see Patent Document 1).

By providing a V-shaped cut portion and a bent portion of a tooth portion end that is bent in the circumferential direction and setting the R dimension of the cut portion end to 30 to 60% of the sheet thickness of a core material, the effect of inhibiting the stator core from bulging in the axial direction is achieved.

As another conventional rotary electric machine, divided cores of a stator have been proposed which include first members formed of silicon steel sheets and having tooth portions for winding a coil thereon and second members that have a lower silicon content than the silicon steel sheet, that are stacked in the central axis direction of the stator on the first members, and that have: tooth portions for winding the coil thereon; and collar portions that are provided at the ends of the tooth portions and that are bent for positioning the coil after insertion of the coil (for example, see Patent Document 2).

By providing the bent portions to the second members that have a lower silicon content and good bending processability, the effect of holding the coil by the second members while high efficiency is achieved by the first members having a higher silicon content is realized.

### CITATION LIST

### Patent Document

Patent Document 1: Japanese Patent No. 5537964

Patent Document 2: Japanese Patent No. 5114354

### SUMMARY OF THE INVENTION

### Problems to be Solved by the Invention

In the conventional stator of the rotary electric machine disclosed in Patent Document 1, a bent portion is formed by stress being concentrated on a portion that is formed between the cut portion and a tooth inner peripheral portion and that has the smallest width in the radial direction. Regarding a shape to be stamped by pressing with a die, even the thinnest portion is generally formed to be larger than a sheet thickness, in view of the life of the die and accuracy. Thus, the bent portion is desirably provided with a width that is at least not less than the sheet thickness.

Meanwhile, the R dimension at the inner side of bending of the bent portion is set to be 30 to 60% of the sheet thickness, and thus there is a problem that when a bent portion having a width that is not less than the sheet thickness is formed by bending with an inner R dimension that is 30 to 60% of the sheet thickness, excessive distortion occurs in a bent outer peripheral portion, resulting in occurrence of a breakage therein.

Therefore, when silicon steel sheets having allowable distortion decreased by adding silicon for the purpose of achieving high efficiency are used, the distortion exceeds the allowable distortion to cause a breakage, so that these sheets cannot be used. Thus, there is a problem that the efficiency decreases.

When electromagnetic force in the radial direction acts on the collar portion, since the R dimension in the radial direction is small, stress is concentrated on the collar portion and cracking develops. Thus, there is a problem that sufficient fatigue strength cannot be ensured.

In the rotary electric machine disclosed in Patent Document 2, since the first members and the second members are used for formation, the materials need to be replaced in the middle of stacking. Thus, there is a problem that the productivity decreases.

When many collar portions are provided, the proportion of the second members having a low silicon content decreases, and thus there is a problem that the efficiency decreases.

Meanwhile, when the number of the collar portions is decreased, the iron loss of a rotor increases, and the efficiency decreases. In addition, the magnetic temperature rises due to the rotor iron loss. Thus, there is a problem that a high-grade magnet has to be used and the material cost increases.

Furthermore, when the number of the collar portions is decreased, there is a problem that desired holding strength for the coil cannot be ensured.

The present invention has been made to solve the above-described problems, and an object of the present invention is to provide a stator for a rotary electric machine, a rotary electric machine, and a method for manufacturing the stator for the rotary electric machine that can inhibit stress concentration and improve fatigue strength.

### Solution to the Problems

A stator for a rotary electric machine of the present invention includes:
a core having a back yoke portion formed in an annular shape and a plurality of tooth portions formed so as to be spaced apart from each other at intervals in a circumferential direction of the back yoke portion and project in a radial direction; and
a coil mounted to a plurality of slots formed between the adjacent tooth portions, via insulating portions, wherein
a collar portion is provided at an end portion at a projection side in the radial direction of each of the tooth portions so as to project to the slot side in the circumferential direction,
the collar portion includes
   a connection portion connected to the tooth portion,
   a bent portion extending from the connection portion in the circumferential direction and forming a first gap across which the bent portion is spaced apart from the end portion of the tooth portion, and
   a stop portion extending from the bent portion in the circumferential direction, projecting at an end side thereof in the circumferential direction to the slot side, and formed so as to have a width in the radial direction larger than a width in the radial direction of the bent portion, and
an R dimension of a side surface, in the circumferential direction and at a side opposite to the projection side of the tooth portion, of the bent portion is not less than the width in the radial direction of the bent portion.

A rotary electric machine of the present invention includes a rotor disposed so as to be concentric with the stator.

A method for manufacturing the stator for the rotary electric machine of the present invention includes:
a first step of forming the core in a state where the collar portions do not project to the slot side in the circumferential direction;
a second step of mounting the coil to the slots of the core via the insulating portions; and
a third step of bending the collar portions in the circumferential direction to project the collar portions to the slot side.

### Effect of the Invention

According to the stator for the rotary electric machine, the rotary electric machine, and the method for manufacturing the stator of the rotary electric machine of the present invention, stress concentration can be inhibited and fatigue strength can be improved.

### BRIEF DESCRIPTION OF THE DRAWINGS

FIG. 1 is a diagram showing the configuration of a rotary electric machine according to Embodiment 1 of the present invention.

FIG. 2 is a plan view showing the configuration of a core of a stator of the rotary electric machine shown in FIG. 1.

FIG. 3 is a plan view showing a state before the core of the stator shown in FIG. 2 is bent.

FIG. 4 is a perspective view showing the configuration of the stator and a rotor of the rotary electric machine shown in FIG. 1.

FIG. 5 is a perspective view showing the configuration of a divided core of the stator of the rotary electric machine shown in FIG. 4.

FIG. 6 is a perspective view showing the configuration of a coil and insulating portions of the stator of the rotary electric machine shown in FIG. 1.

FIG. 7 is a side view showing a method for manufacturing the stator of the rotary electric machine shown in FIG. 1.

FIG. 8 is a plan view showing the method for manufacturing the stator of the rotary electric machine shown in FIG. 1.

FIG. 9 is a perspective view showing the method for manufacturing the stator of the rotary electric machine shown in FIG. 1.

FIG. 10 is a side view showing the method for manufacturing the stator of the rotary electric machine shown in FIG. 1.

FIG. 11 is a plan view showing the method for manufacturing the stator of the rotary electric machine shown in FIG. 1.

FIG. 12 is a perspective view showing the method for manufacturing the stator of the rotary electric machine shown in FIG. 1.

FIG. 13 is a plan view showing a method for producing a portion indicated by S in the stator shown in FIG. 11.

FIG. 14 is a plan view showing the method for producing the portion indicated by S in the stator shown in FIG. 11.

FIG. 15A shows plan views showing the configuration of a stator of a comparative example for describing the advantageous effects of Embodiment 1.

FIG. 15B shows plan views showing the configuration of a stator of a comparative example for describing the advantageous effects of Embodiment 1.

FIG. 16 is a plan view for describing the principle of the advantageous effects of Embodiment 1.

FIG. 17 is a plan view for describing the principle of the comparative example for describing the advantageous effects of Embodiment 1.

FIG. 18 is a plan view showing another example of the core of the stator of Embodiment 1 of the present invention.

FIG. 19 is a plan view showing the configuration of a core of a stator according to Embodiment 2 of the present invention.

FIG. 20 is a plan view showing a state before the core of the stator shown in FIG. 19 is bent.

FIG. 21 is a plan view showing the configuration of a core of a stator according to Embodiment 3 of the present invention.

FIG. 22 is a plan view showing a state before the core of the stator shown in FIG. 21 is bent.

FIG. 23 is a plan view showing the configuration of a core of a stator according to Embodiment 4 of the present invention.

FIG. 24 is a plan view showing a state before the core of the stator shown in FIG. 23 is bent.

FIG. 25 is a plan view showing the state before the core of the stator shown in FIG. 24 is bent.

### DESCRIPTION OF EMBODIMENTS

### Embodiment 1

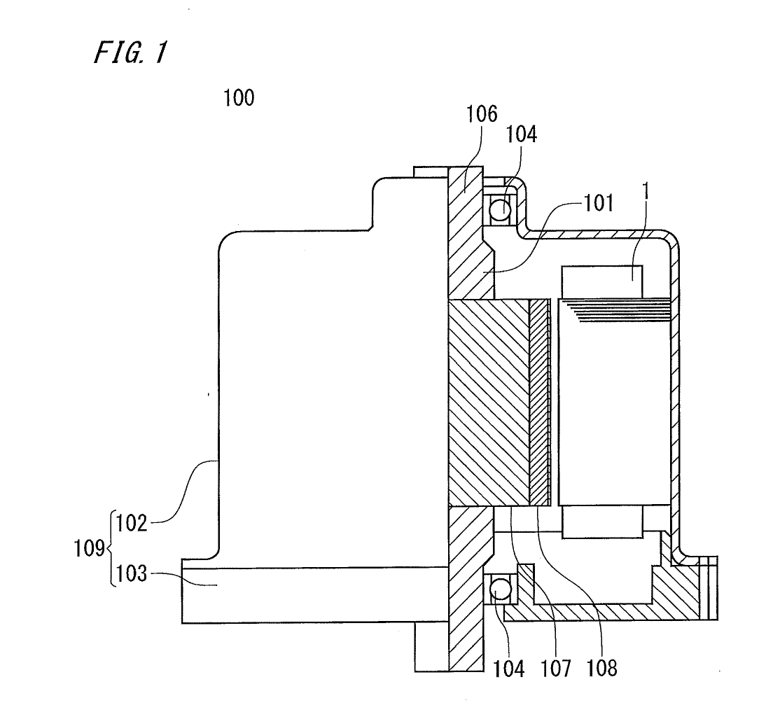

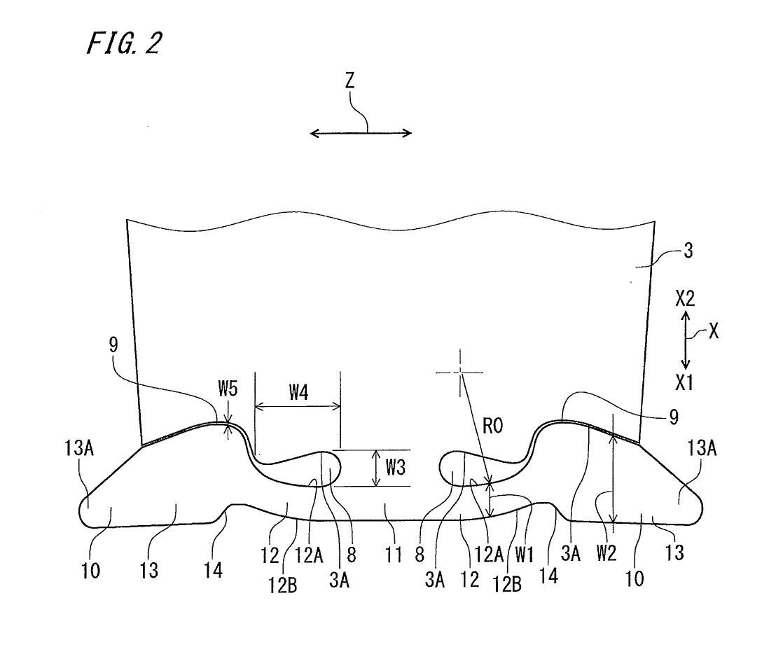

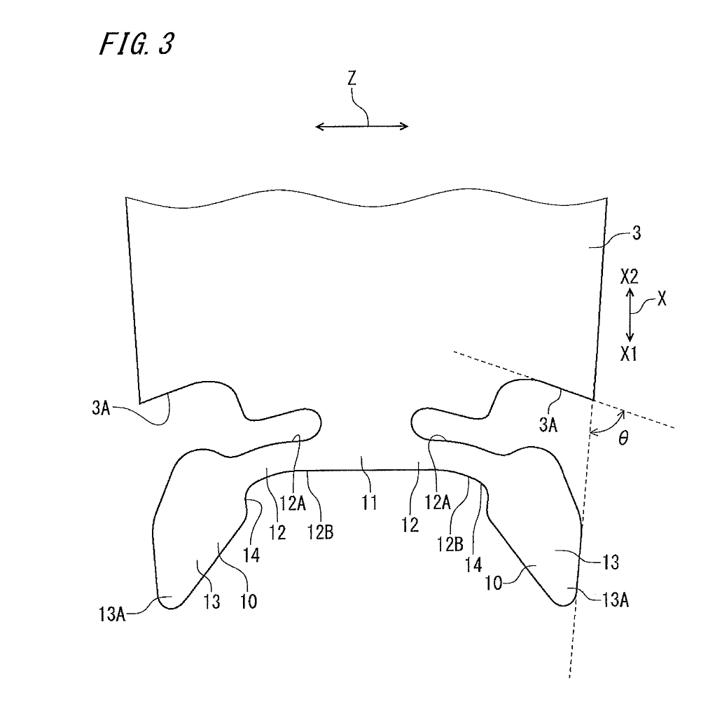

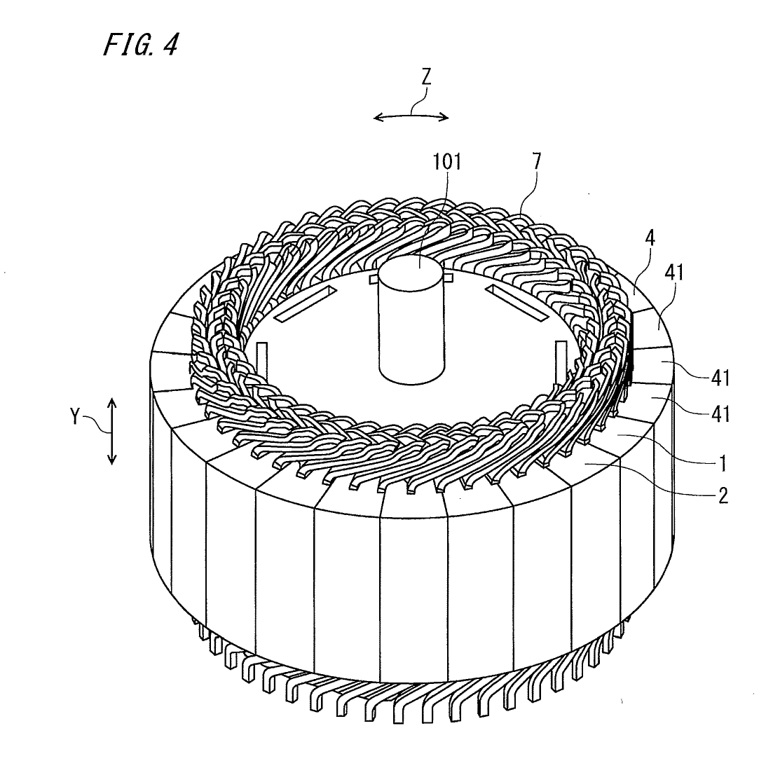

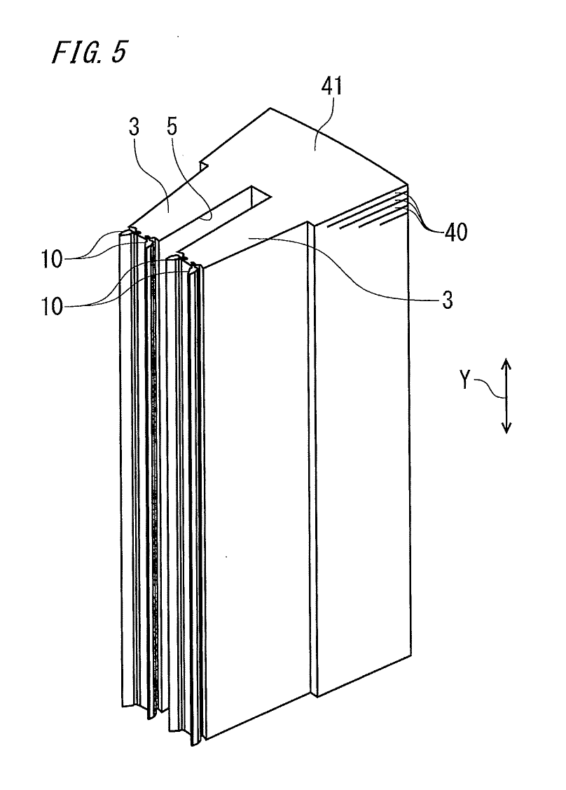

Hereinafter, embodiments of the invention of the present application will be described. FIG. 1 is a single-side longitudinal sectional side view showing the configuration of a rotary electric machine of Embodiment 1 of the present invention. FIG. 2 is a plan view showing the configuration of a tooth portion of a core of a stator of the rotary electric machine shown in FIG. 1. FIG. 3 is a plan view showing a state before collar portions of the tooth portion of the core of the stator shown in FIG. 2 are bent. FIG. 4 is a perspective view showing the configuration of the stator and a rotor of the rotary electric machine shown in FIG. 1. FIG. 5 is a perspective view showing the configuration of a divided core of the stator of the rotary electric machine shown in FIG. 4.

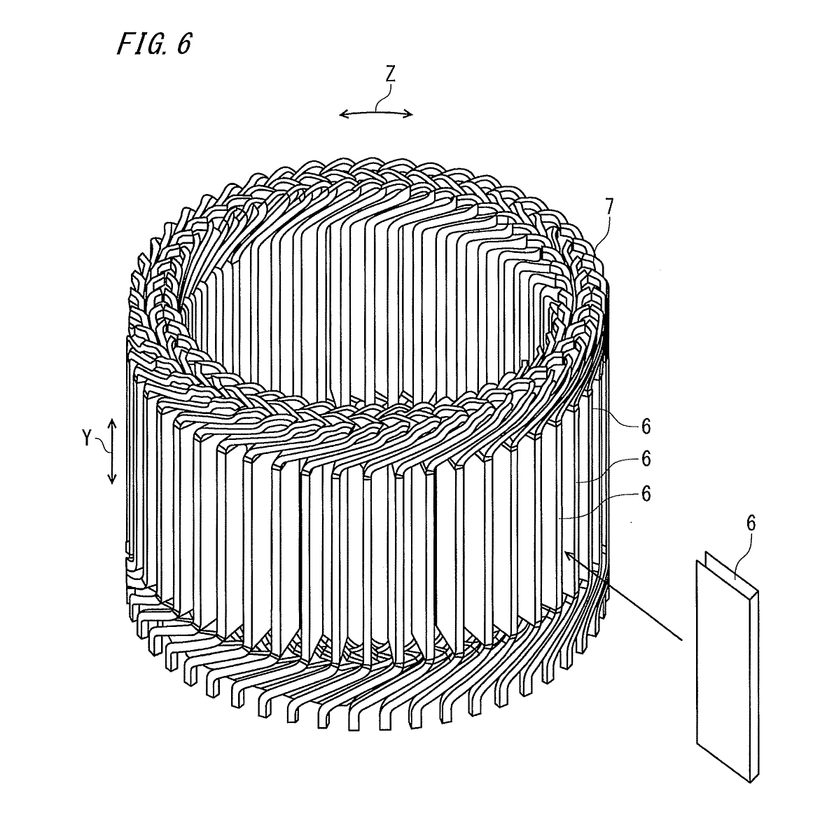

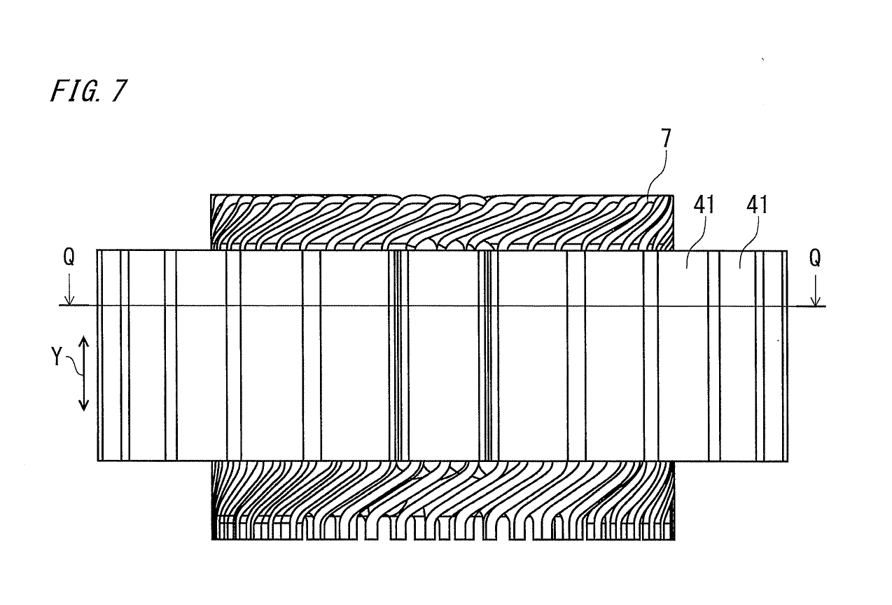

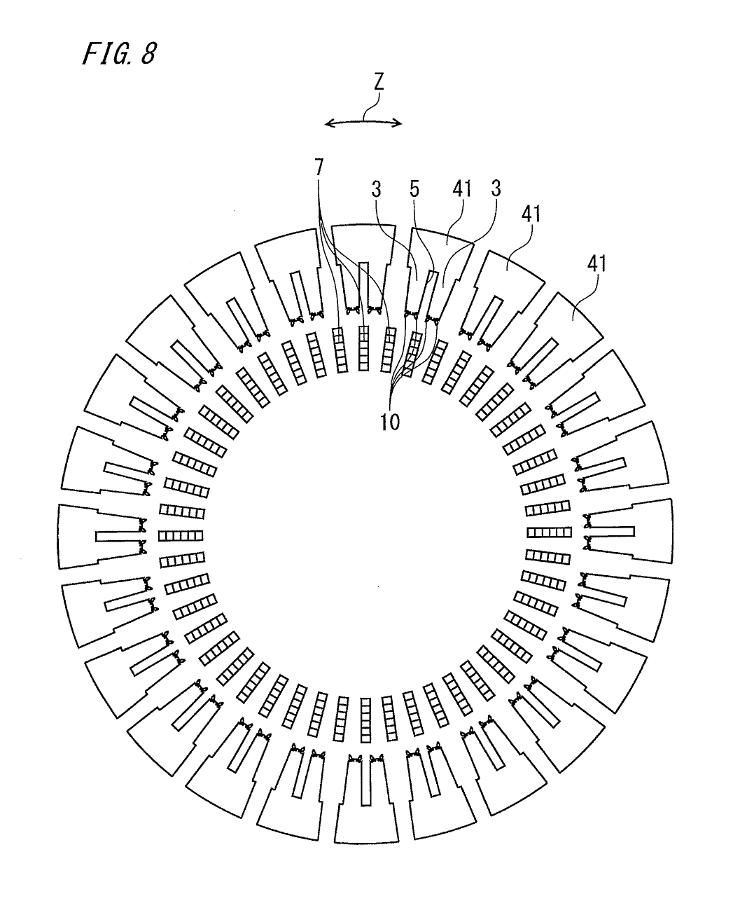

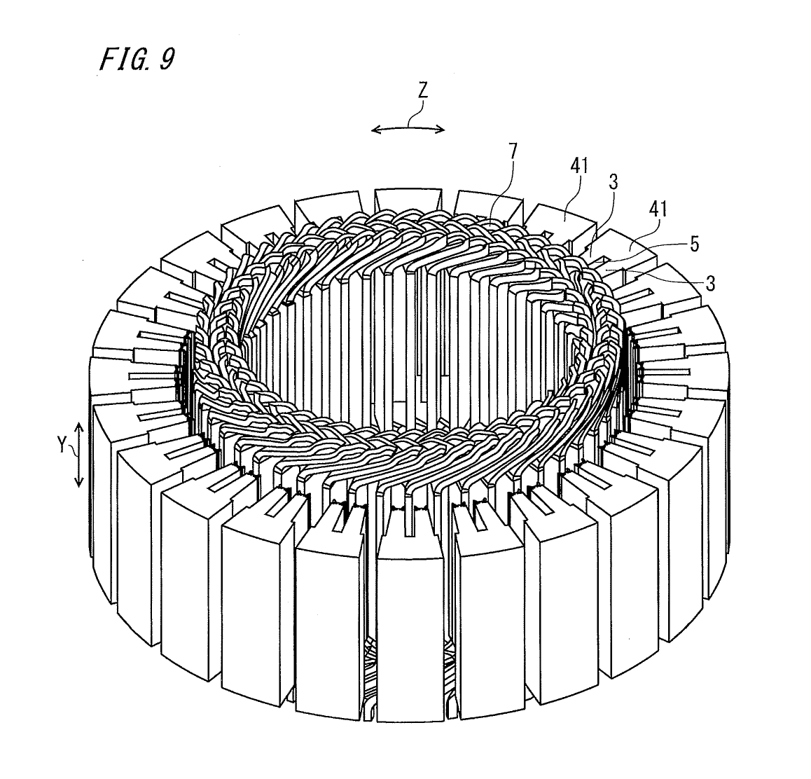

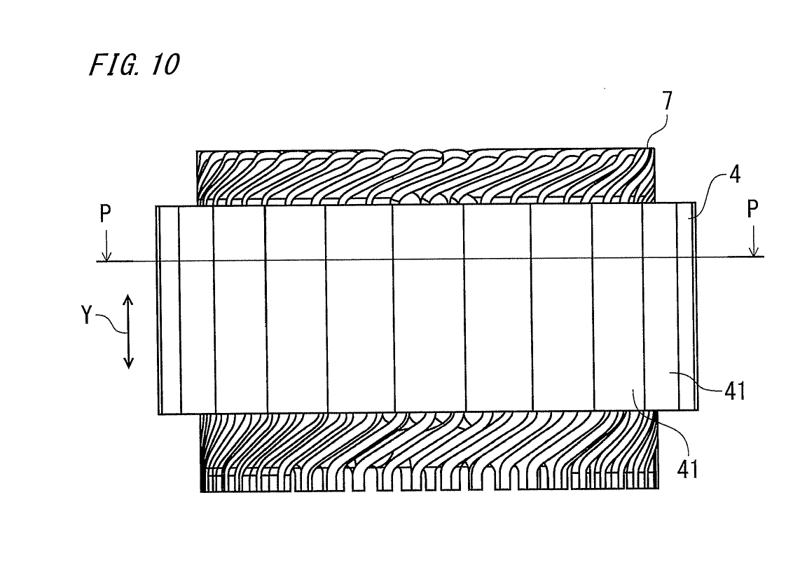

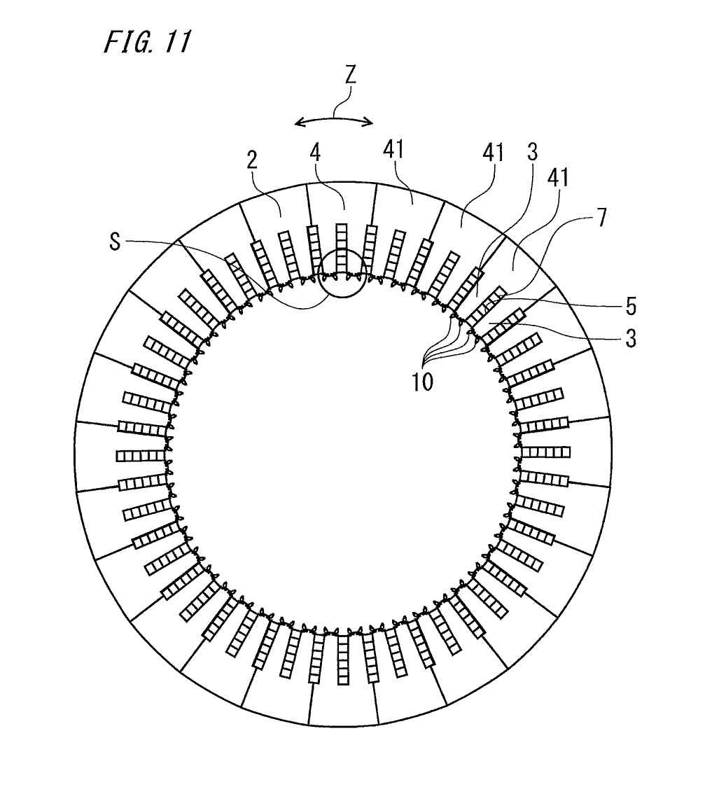

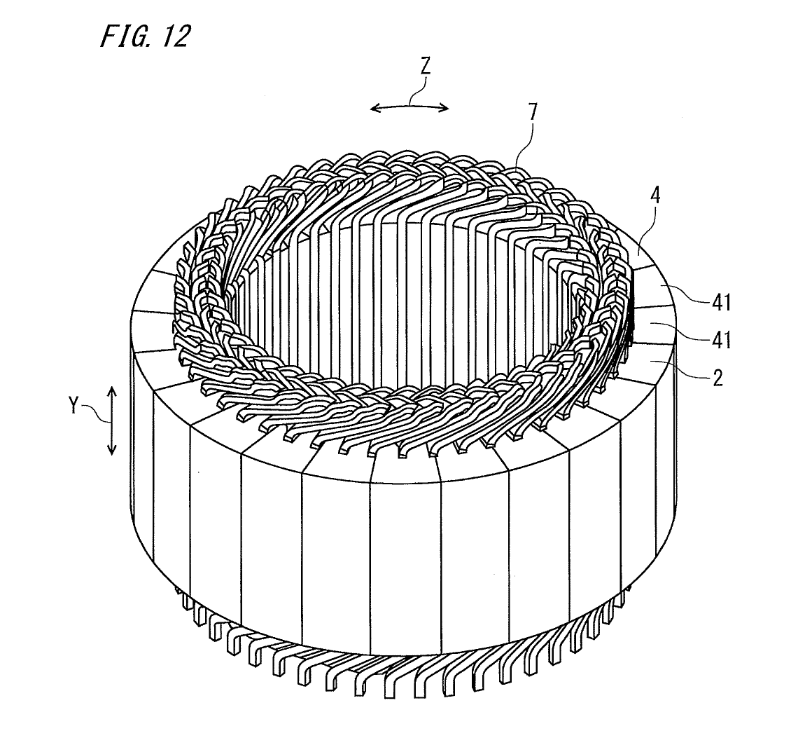

FIG. 6 is a perspective view showing the configuration of a coil and insulating portions of the stator of the rotary electric machine shown in FIG. 1. FIG. 7 is a side view showing a method for manufacturing the stator of the rotary electric machine shown in FIG. 1. FIG. 8 is a plan view along a line Q-Q shown in FIG. 7, showing the method for manufacturing the stator of the rotary electric machine. FIG. 9 is a perspective view at the same time as FIG. 7 and FIG. 8, showing the method for manufacturing the stator of the rotary electric machine. FIG. 10 is a side view in a step next to FIG. 8, showing the method for manufacturing the stator of the rotary electric machine. FIG. 11 is a plan view along a line P-P shown in FIG. 10, showing the method for manufacturing the stator of the rotary electric machine. FIG. 12 is a perspective view at the same time as FIG. 10 and FIG. 11, showing the method for manufacturing the stator of the rotary electric machine.

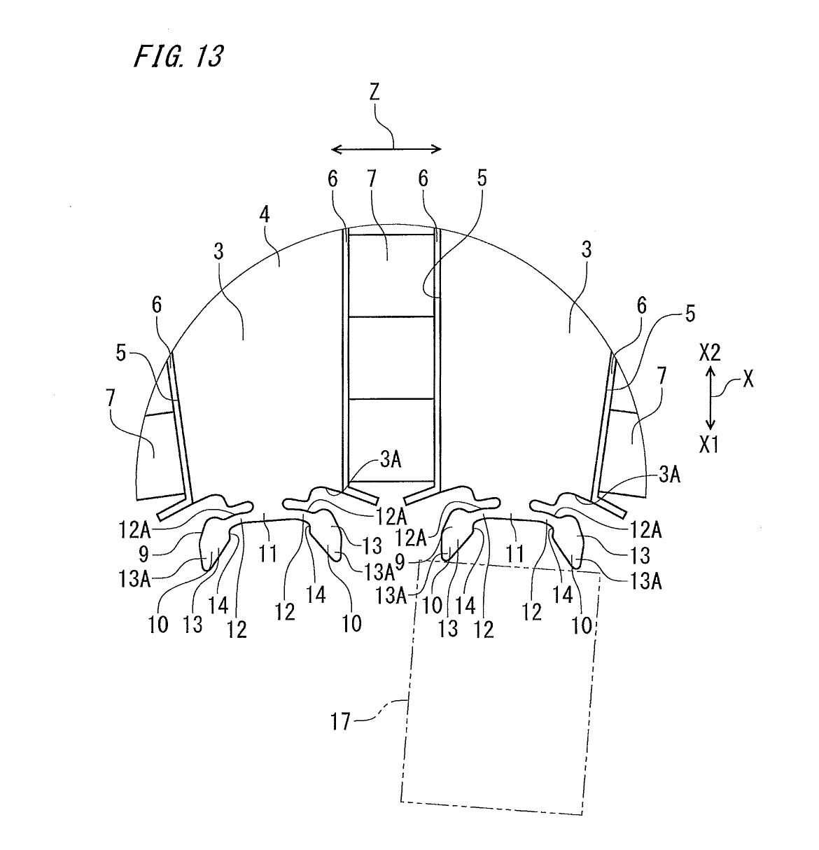

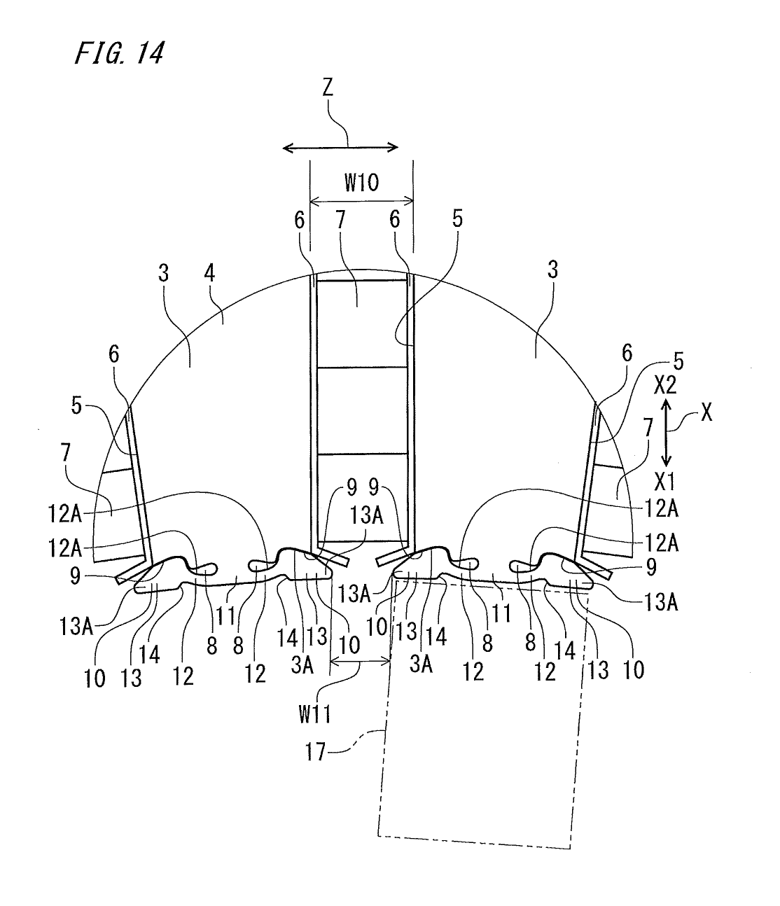

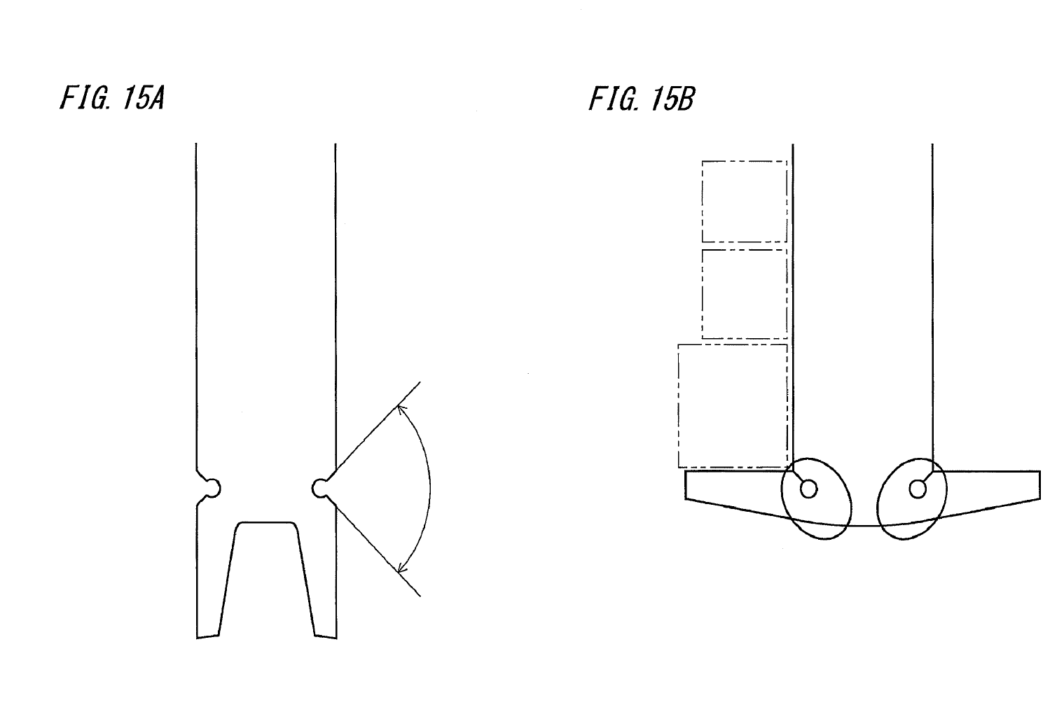

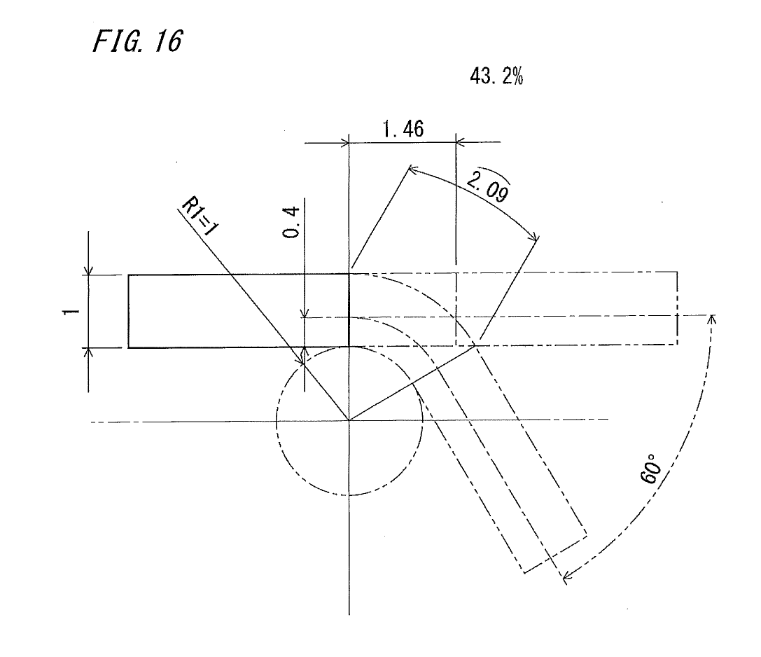

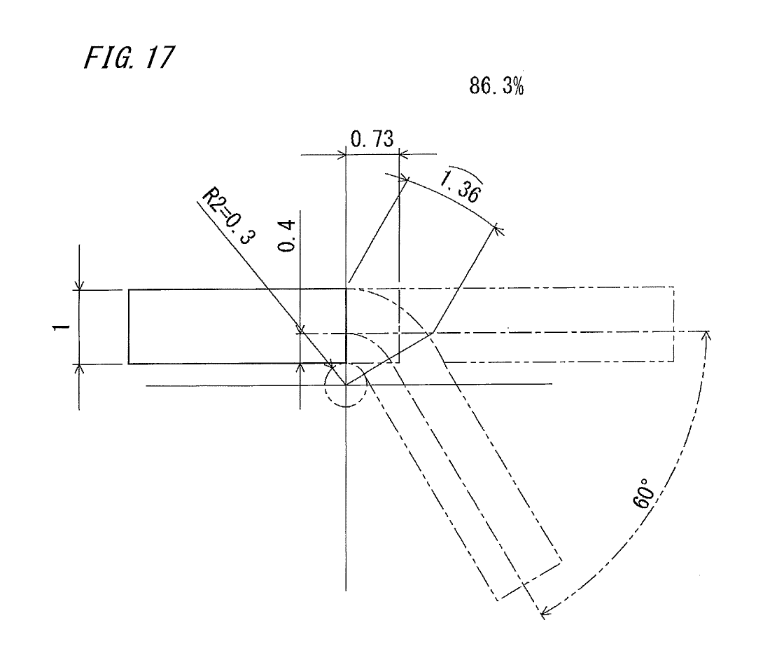

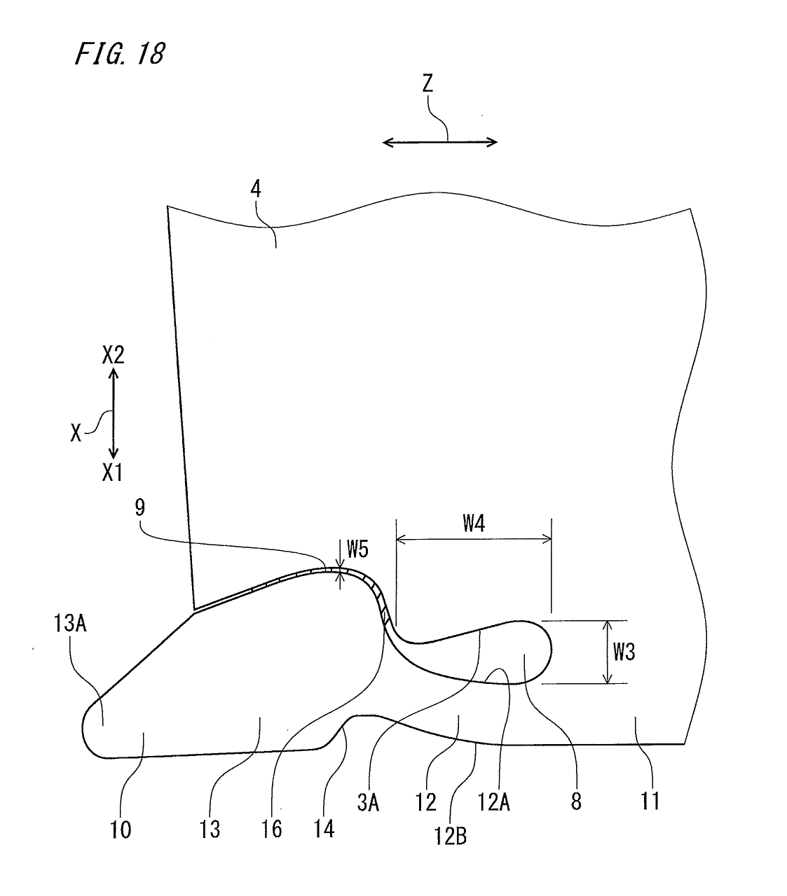

FIG. 13 is a plan view showing a method for producing a portion indicated by S in the stator shown in FIG. 11. FIG. 14 is a plan view in a step next to FIG. 13, showing the method for producing the portion indicated by S in the stator shown in FIG. 11. FIG. 15A and FIG. 15B shows plan views showing the configuration of a stator of a comparative example for describing the advantageous effects of Embodiment 1. FIG. 16 is a plan view for describing the principle of the advantageous effects of Embodiment 1. FIG. 17 is a plan view for describing the principle of the comparative example for describing the advantageous effects of Embodiment 1. FIG. 18 is a plan view showing another example of the core of the stator of Embodiment 1 of the present invention.

In FIG. 1, a rotary electric machine 100 includes a stator 1 and a rotor 101 disposed within an annular shape of the stator 1. The rotary electric machine 100 is housed in a housing 109 that includes: a frame 102 having a cylindrical shape with a bottom; and an end plate 103 closing the opening of the frame 102. The stator 1 is fixed within the cylindrical portion of the frame 102 in a fitted state. The rotor 101 is fixed to a rotation shaft 106 that is rotatably supported by the bottom portion of the frame 102 and the end plate 103 via a bearing 104.

The rotor 101 is formed by: a rotor core 107 that is fixed to the rotation shaft 106 inserted at an axial position; and permanent magnets 108 that are embedded at the outer peripheral surface side of the rotor core 107 and arranged at predetermined intervals in a circumferential direction Z and that form magnetic poles. The rotor 101 is shown as a permanent-magnet-type rotor here, but is not limited thereto, and a squirrel cage rotor in which conductor wires not provided with an insulating coating are accommodated in slots and short-circuited at both sides by short-circuit rings, or a wound rotor in which conductor wires provided with an insulating coating are mounted to slots of a rotor core, may be used.

The stator 1 includes a core 4 and a coil 7. The core 4 has: a back yoke portion 2 that is formed in an annular shape; and a plurality of tooth portions 3 that are formed so as to be spaced apart from each other at regular intervals in the circumferential direction Z of the inner circumference of the back yoke portion 2 and project to an inner side X1 in a radial direction X. The coil 7 is mounted to a plurality of slots 5 formed between the adjacent tooth portions 3, via insulating portions 6. The slots 5 are formed so as to penetrate in an axial direction Y. The back yoke portion 2 magnetically connects the respective tooth portions 3.

The core 4 is formed by connecting, in an annular shape, a plurality of divided cores 41 divided in the circumferential direction Z and shown in FIG. 5. One divided core 41 is formed with two tooth portions 3. A structure, such as a distributed winding type in which the coil 7 is wound over a plurality of the tooth portions 3 and a concentrated winding type in which the coil 7 is wound on one tooth portion 3, is applicable to the coil 7. In Embodiment 1, a description will be given with a distributed winding type as an example.

The core 4 is formed, for example, by stacking, in the axial direction Y, a plurality of sheets 40 obtained by stamping an electromagnetic steel sheet containing silicon with a press or the like. The sheets 40 stacked in the axial direction Y are fixed by fixing means such as swaging, welding, and bonding. Here, an example in which each insulating portion 6 is formed as a member separate from the core 4 is shown, but the insulating portions 6 and the core 4 may be integrally formed by fixing means such as injection molding.

At a projection side in the radial direction X of each tooth portion 3, here, at an end portion 3A at the inner side X1 in the radial direction X, collar portions 10 are formed at both sides in the circumferential direction Z so as to project to the slot 5 side in the circumferential direction Z. Here, the side opposite to the projection side in the radial direction X is referred to as outer side X2 in the radial direction X.

Each collar portion 10 includes a connection portion 11, a bent portion 12, and a stop portion 13. The connection portion 11 is formed so as to be connected to a center portion in the circumferential direction Z of the end portion 3A of the tooth portion 3. The bent portion 12 is formed so as to extend from the connection portion 11 to each side in the circumferential direction Z. The bent portion 12 forms a first gap 8 across which the bent portion 12 is spaced apart from the end portion 3A of the tooth portion 3. The first gap 8 is formed such that a width W3 thereof in the radial direction X is smaller than a width W4 thereof in the circumferential direction Z. An R dimension R0 of a circumferential side surface 12A of the bent portion 12 at the side (inner side X1) opposite to the projection side (outer side X2) of the tooth portion 3 indicates a radius that provides a smooth curved line after the collar portion 10 is bent in the circumferential direction Z as shown in FIG. 2, and the R dimension R0 is set so as to be not less than a width W1 in the radial direction X of the bent portion 12. In addition, the width W1 in the radial direction X of the bent portion 12 is set so as to be uniform. A recess 14 is formed on a circumferential side surface 12B at the inner side X1 of the bent portion 12.

The stop portions 13 are formed so as to extend from the bent portions 12 to both sides in the circumferential direction Z. Each stop portion 13 is formed such that an end side 13A thereof in the circumferential direction Z projects to the slot 5 side. The stop portion 13 is formed such that a width W2 thereof in the radial direction X is larger than the width W1 in the radial direction X of the bent portion 12. In addition, the stop portion 13 and the end portion 3A of the tooth portion 3 form a second gap 9. The second gap 9 is formed such that a width W5 thereof in the radial direction X is smaller than the width W3 in the radial direction X of the first gap 8.

Next, a method for manufacturing the stator of the rotary electric machine of Embodiment 1 configured as described above will be described. First, as shown in FIG. 6, the insulating portions 6 are mounted at predetermined locations on the coil 7 that is wound in a desired shape. In addition, as shown in FIG. 3 and FIG. 5, the divided cores 41 are formed in a state where the collar portions 10 do not project to the slot 5 side in the circumferential direction Z (a first step). Next, as shown in FIG. 7, FIG. 8, and FIG. 9, the divided cores 41 are disposed at the outer peripheral side of the coil 7 on which the insulating portions 6 have been mounted.

Next, as shown in FIG. 10, FIG. 11, and FIG. 12, the divided cores 41 are moved toward the inner side X1 in the radial direction X, and the coil 7 is mounted to the divided cores 41 (a second step). In this manner, the plurality of divided cores 41 are connected, so that the core 4 is formed and the annular back yoke portion 2 is formed. The slots 5 are formed by the tooth portions 3 of the plurality of divided cores 41. Accordingly, the insulating portions 6 and the coil 7 formed in the previous step are disposed within the slots 5. It is noted that the insulating portions 6 are omitted in FIG. 10, FIG. 11, and FIG. 12.

Next, as shown in FIG. 13, a jig 17 is installed at the inner side X1 in the radial direction X of the core 4 so as to oppose the positions at which the collar portions 10 are formed. Next, as shown in FIG. 14, the position of the core 4 is made fixed, and the jig 17 is moved toward the outer side X2 in the radial direction X and pressed against the collar portions 10. Accordingly, in the collar portions 10, the bent portions 12 are deformed to be bent, and the stop portions 13 are moved to the end portion 3A side of the tooth portion 3. A bending angle θ of each collar portion 10 from FIG. 13 to FIG. 14 is an angle as shown in FIG. 3. Accordingly, the end side 13A of each stop portion 13 projects to the slot 5 side in the circumferential direction Z (a third step).

Since the collar portions 10 are formed so as to project to the slot 5 side in the circumferential direction Z, the slot 5 is formed such that a width W11 thereof in the circumferential direction Z at the inner side X1 in the radial direction X (the opening side of the slot 5) is smaller than a width W10 thereof in the circumferential direction Z at the outer side X2 in the radial direction X. Thus, the effect of reducing rotor loss and achieving high efficiency is realized as compared to the case where the width in the circumferential direction Z of the slot 5 at the inner side X1 of the radial direction X (at the opening side of the slot 5) is equal to the width in the circumferential direction Z of the slot 5 at the outer side X2 in the radial direction X. Furthermore, the magnet temperature decreases by reducing the rotor loss, so that use of low-grade magnets is enabled, resulting in lower costs.

Moreover, the R dimension R0 of the circumferential side surface 12A of the bent portion 12 is set so as to be not less than the width W1 in the radial direction X of the bent portion 12. The first gap 8, across which the bent portion 12 and the end portion 3A of the tooth portion 3 are spaced apart from each other, is formed. Since the first gap 8 is formed such that the width W3 thereof in the radial direction X is smaller than the width W4 thereof in the circumferential direction Z, the R dimension R0 that makes the circumferential side surface 12A of the bent portion 12 a smooth curved surface can be easily ensured. In addition, the circumferential side surface 12A of the bent portion 12 is formed in a round shape with the smooth R dimension R0 so as to be connected to the connection portion 11 and the stop portion 13. Thus, during bending, stress concentration does not occur and stress is uniformly generated, so that the effect that a breakage is less likely to occur is achieved.

In shaping the collar portions 10 by the jig 17, the collar portions 10 can be stably shaped by bringing the stop portions 13 into contact with the end portion 3A of the tooth portion 3, so that the effect of reducing torque ripple and cogging torque is achieved. During shaping, the stop portions 13 are brought into contact with the end portion 3A of the tooth portion 3 by the jig 17, but when the jig 17 is removed thereafter, the second gaps 9 are formed between the stop portions 13 and the end portion 3A of the tooth portion 3.

Since the bent portion 12 is formed such that the width W1 thereof in the radial direction X is smaller than the width W2 in the radial direction X of the stop portion 13, portions that plastically deforms are concentrated in the bent portion 12. Therefore, bending can be achieved with small force, so that the effect of low-cost manufacturing is achieved.

The principle of the advantageous effect at the R dimension R0 of the circumferential side surface 12A of the bent portion 12 of the present embodiment will be described. For this, configurations for simply and relatively comparing the present embodiment and the comparative example in difference will be described with reference to FIG. 16 and FIG. 17. FIG. 16 shows an example of the bent portion of the present embodiment. FIG. 17 shows the comparative example.

As shown in FIG. 15A and FIG. 15B, in the comparative example, the relationship between the bent portion and R is not explicitly shown. However, regarding the width W1 in the radial direction X of the bent portion 12 in the present embodiment, in the case of stamping with a die press, a portion having the minimum width desirably has a width that is at least not less than a sheet thickness, in terms of accuracy. Therefore, here, for the case where the sheet thickness is set to 1 mm, the example of the present embodiment and the comparative example are compared and shown in FIG. 16 and FIG. 17, respectively. Specifically, the width W1 in the radial direction X of the bent portion 12 is set to 1 mm, and calculation is performed on the assumption that the bending angle is 60° and the neutral axis of the bent portion 12 is located at a position corresponding to 40% of the width in the radial direction X. The position of the neutral axis of the bent portion is empirically known to be at about 40% of the width in the radial direction.

FIG. 16 shows the case of R1=1 mm, that is, having an R radius equal to the sheet thickness that is the lower limit of the R dimension R0 of the bent portion 12 of the present embodiment. FIG. 17 shows the case of R2=0.3 mm, that is, having an R radius that is 30% of the sheet thickness, as the comparative example. The results of comparison of distortion amounts in these cases are shown. As shown in FIG. 17, in the comparative example, a distortion of 86.3% (=1.36÷0.73) occurs in the outer peripheral portion. On the other hand, as shown in FIG. 16, in the present embodiment, only a distortion of 43.2% (=2.09·1.46) occurs in the outer peripheral portion. As described above, it is found that in the case of bending by the same angle, the distortion can be reduced to about half.

Since the distortion can be reduced as described above, silicon steel sheets having a small allowance for distortion and a high silicon content (for example, not less than 1%) can be used as the sheets 40, so that high efficiency can be achieved. Three parameters, that is, the R dimension R0 of the circumferential side surface 12A of the bent portion 12, the width W1 in the radial direction X of the bent portion 12, and the bending angle θ, can be arbitrarily set in accordance with the allowable elongation of each sheet 40 such that the sheet 40 satisfies R0≥W1. Specifically, the three parameters, that is, the R dimension R0 of the circumferential side surface 12A of the bent portion 12, the width W1 in the radial direction X of the bent portion 12, and the bending angle θ, are adjusted such that distortion occurring in the bent portion 12 is not greater than the allowable elongation of the sheet 40, whereby the risk of breakage during bending of the collar portion 10 is reduced and a rotary electric machine having high reliability can be obtained.

Since the core 4 is formed of the plurality of divided cores 41 divided in the circumferential direction Z, use of a member having a larger allowable elongation in the circumferential direction Z than an allowable elongation thereof in the radial direction X as each divided core 41 is conceivable. This is because elongation mainly in the circumferential direction Z occurs in the collar portion 10 when the collar portion 10 projecting in the radial direction X is bent in the circumferential direction Z. Therefore, by using a member having a larger allowable elongation in the circumferential direction Z than an allowable elongation thereof in the radial direction X as each divided core 41, the risk of breakage during bending of the collar portion 10 is reduced and a rotary electric machine having high reliability can be obtained. The “allowable elongation” refers to an amount by which the member elongates until being broken.

When electromagnetic force in the radial direction X repeatedly acts on the collar portion 10, stress acts on the bent portion 12. At this time, since the R dimension R0 of the circumferential side surface 12A of the bent portion 12 is large, the effect of inhibiting stress concentration and improving fatigue strength is achieved. In addition, since the collar portion 10 is formed over the entire region in the axial direction Y, the effect of reducing iron loss of the stator 1 and improving the efficiency is achieved. Moreover, the magnet temperature becomes less likely to rise, and thus the amount of dysprosium or terbium to be added to the magnets in order to improve the holding power of the magnets can be reduced, so that the effect of resource savings is achieved.

Since the collar portion 10 is formed over the entire region in the axial direction Y, the effect of assuredly holding the coil 7 within the slot 5 is achieved. In addition, the width W1 in the radial direction X of the bent portion 12 is desirably not less than the thickness of each sheet 40, which forms the core 4. By setting such a width, the width accuracy becomes stable and the effect of reducing torque ripple and cogging torque is achieved.

Since the width W1 in the radial direction X of the bent portion 12 is uniform and the recess 14 is provided on the circumferential side surface 12B of the bent portion 12, the effect of averaging the distortion occurring in the bent portion 12 and reducing the maximum distortion is achieved.

By reducing the distortion, a bulge in the axial direction Y of the inner peripheral portion of the bent portion 12 can be reduced. Therefore, the present embodiment achieves the effect of reducing the bulge in the axial direction Y more than in the comparative example.

The stop portion 13 and the end portion 3A of the tooth portion 3 form the second gap 9. In addition, the width W5 in the radial direction X of the second gap 9 is smaller than the width W3 in the radial direction X of the first gap 8.

By forming the second gap 9, noise generated due to contact between the collar portion 10 and the tooth portion 3 when the collar portion 10 is vibrated by electromagnetic force is reduced, so that the effect of achieving low noise is realized.

Since the width W5 of the second gap 9 is set so as to be smaller than the width W3 of the first gap 8, a magnetic flux in the radial direction X that passes through the bent portion 12 having large magnetic resistance in the radial direction X is reduced, and a magnetic flux that passes through the connection portion 11 and the stop portion 13 of the tooth portion 3 is increased. Since the magnetic flux passing through the bent portion 12 that is deteriorated due to processing is reduced, the effect of achieving high efficiency is realized.

As shown in FIG. 18, a cushioning material 16 may be provided in the second gap 9. By providing the cushioning material 16 as described above, attenuation occurs when the collar portion 10 vibrates, so that the effect of reducing resonance magnification during resonance and improving fatigue strength is achieved. A thermosetting resin such as epoxy resins and acrylic resins is desirably used as the cushioning material 16. By using these resins, the resins in a liquid state can be filled into the second gap 9. Thus, the cushioning material 16 can be easily provided.

The cushioning material 16 does not necessarily need to be provided in all the second gaps 9, but only needs to be provided in at least some of the second gaps 9.

According to the stator of the rotary electric machine, the rotary electric machine, and the method for manufacturing the stator of the rotary electric machine of Embodiment 1 configured as described above, since the R dimension of the bent portion is set so as to be not less than the width in the radial direction of the bent portion, the effect of inhibiting stress concentration and improving fatigue strength is achieved.

In addition, since the collar portion projecting to the slot side in the circumferential direction is provided over the overall length in the axial direction, the effect of reducing rotor iron loss and improving the efficiency is achieved.

Accordingly, the magnet temperature becomes less likely to rise, and thus low-grade magnets can be used, so that the effect of achieving low cost is realized.

Furthermore, the effect of assuredly holding the coil within the slots is achieved by the collar portions.

Since the first gap is formed such that the width thereof in the circumferential direction is large and the width thereof in the radial direction is small, stress is alleviated, distortion is reduced, and further magnetic resistance is reduced, so that the effect of achieving high output is achieved.

Since the second gap is formed between the stop portion and the tooth portion, generation of noise due to contact between the stop portion and the end portion of the tooth portion when the stop portion is vibrated by electromagnetic force is reduced, so that the effect of achieving low noise is realized.

Since the second gap is formed such that the width thereof in the radial direction is smaller than the width in the radial direction of the first gap, the magnetic flux in the radial direction that passes through the bent portion having large magnetic resistance in the radial direction is reduced, and the magnetic flux that passes through the collar portion and the center portion in the circumferential direction of the tooth portion is increased. Since the magnetic flux passing through the bent portion that is deteriorated due to processing is reduced as described above, the effect of achieving high efficiency is realized.

Since the cushioning material is provided in the second gap, the effect of reducing vibration and noise is achieved.

Since the bent portion is formed such that the width thereof in the radial direction is not less than the sheet thickness of the sheet, the accuracy of shaping the bent portion becomes stable and the effect of reducing torque ripple and cogging torque is achieved.

Since the sheets forming the core are formed of electromagnetic steel sheets containing silicon, the effect of achieving high efficiency is realized. Furthermore, the risk of breakage during bending of the collar portion is reduced and a rotary electric machine having high reliability can be obtained.

Since the core is formed of the plurality of divided cores divided in the circumferential direction, and each divided core is formed of a member having a larger allowable elongation in the circumferential direction than an allowable elongation thereof in the radial direction, the risk of breakage during bending of the collar portion is reduced and a rotary electric machine having high reliability can be obtained.

Since the collar portion does not project to the slot side before the coil is inserted into the slot (the first step), the coil can be assembled to the slot without interference with the collar portion.

The example in which the divided cores divided in the circumferential direction Z are used has been described in the present embodiment, but the present invention is not limited thereto and the core can be similarly configured as an integral type. The present invention is applicable to an outer rotary type rotary electric machine as well as an inner rotary type rotary electric machine. The same also applies to the following embodiments, and thus such description is omitted as appropriate.

### Embodiment 2

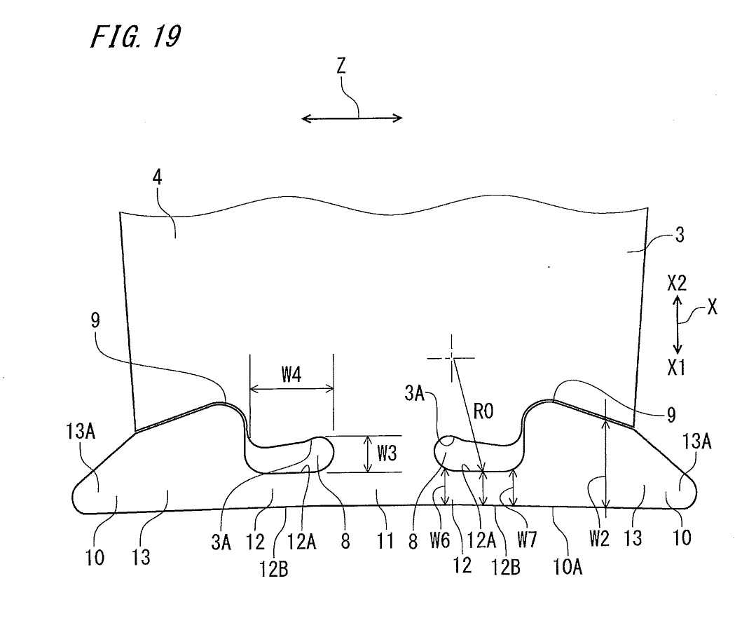

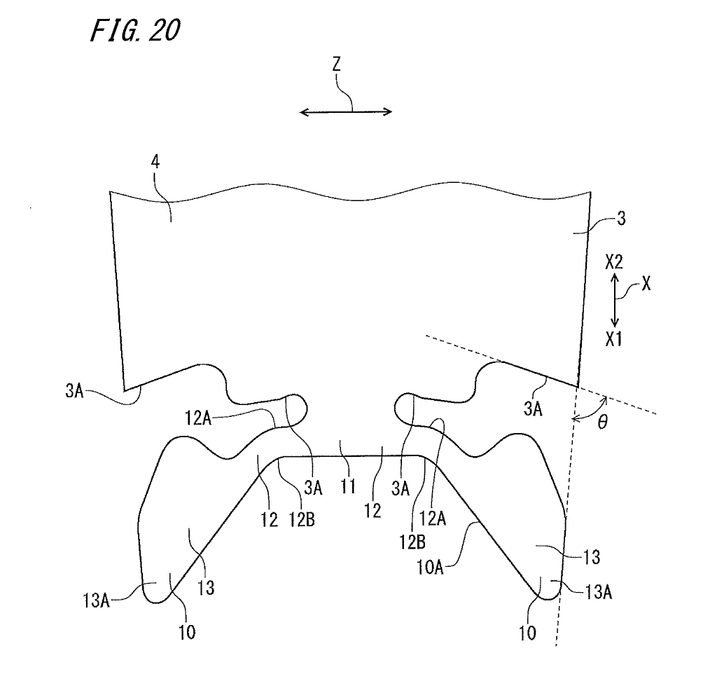

FIG. 19 is a plan view showing the configuration of an end portion of a tooth portion of a stator of a rotary electric machine according to Embodiment 2 of the present invention. FIG. 20 is a plan view showing a state before collar portions of the tooth portion shown in FIG. 19 are bent.

In the drawings, the same parts as in Embodiment 1 described above are designated by the same reference characters, and the description thereof is omitted. In Embodiment 2, each bent portion 12 does not have a recess 14 formed thereon, unlike Embodiment 1 described above. However, the bent portion 12 is formed such that a width W6 thereof in the radial direction X at the connection portion 11 side is equal to a width W7 thereof in the radial direction X at the stop portion 13 side. Thus, after the collar portions 10 are bent, circumferential side surfaces 10A at the inner side X1 in the radial direction X of the collar portions 10 are formed in a substantially straight manner in the circumferential direction Z.

According to the stator of the rotary electric machine of Embodiment 2 configured as described above, as a matter of course, the same advantageous effects as in Embodiment 1 described above are achieved. In addition, since a recess as shown in Embodiment 1 described above is not formed on the bent portion, the magnetic resistance is reduced, and the effect of achieving high output can be realized.

### Embodiment 3

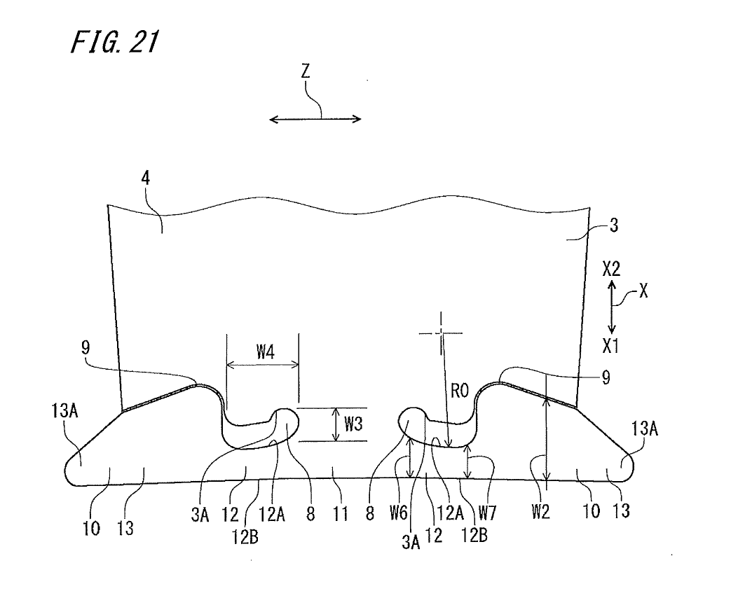

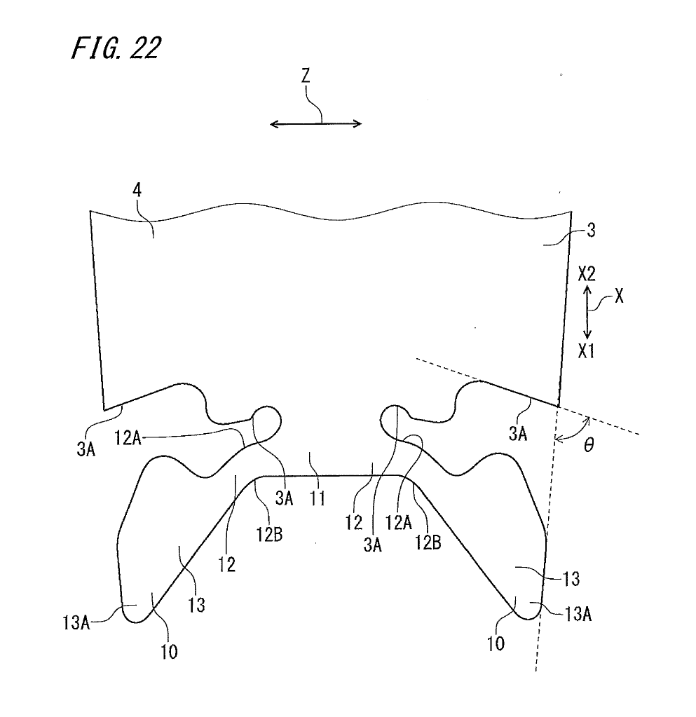

FIG. 21 is a plan view showing the configuration of an end portion of a tooth portion of a stator of a rotary electric machine according to Embodiment 3 of the present invention. FIG. 22 is a plan view showing a state before collar portions of the tooth portion shown in FIG. 21 are bent. In the drawings, the same parts as in each embodiment described above are designated by the same reference characters, and the description thereof is omitted. Each bent portion 12 is formed such that the width W6 thereof in the radial direction X at the connection portion 11 side is larger than the width W7 thereof in the radial direction X at the stop portion 13 side.

According to the stator of the rotary electric machine of Embodiment 3 configured as described above, as a matter of course, the same advantageous effects as in each embodiment described above are achieved. In applying pressure in the radial direction with the jig to bend the bent portion, large moment acts on the connection portion side. At this time, since the width at the connection portion side is larger than the width at the stop portion side, distortion in the bent portion becomes uniform, and the effect of further reducing the maximum distortion is achieved.

### Embodiment 4

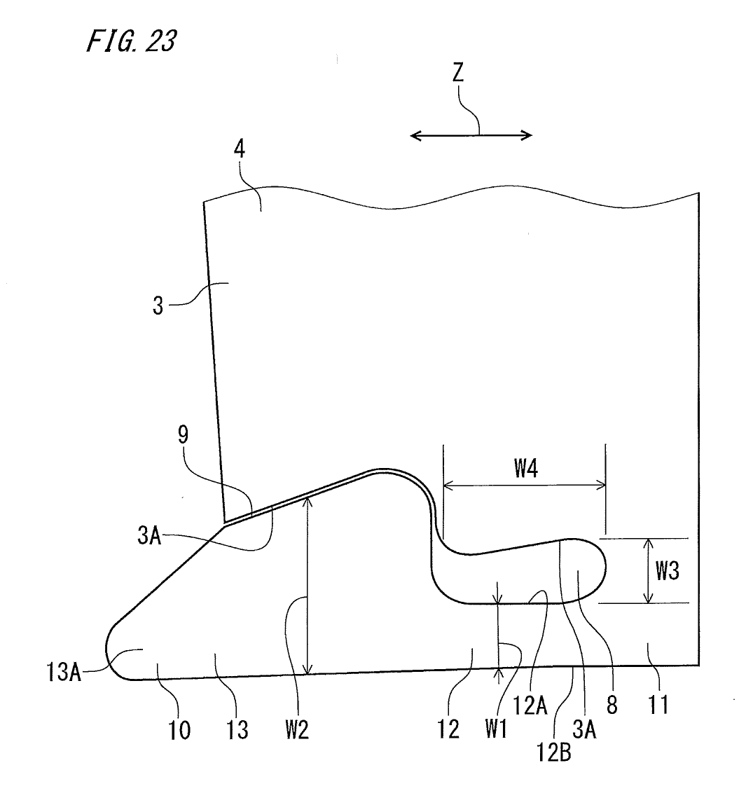

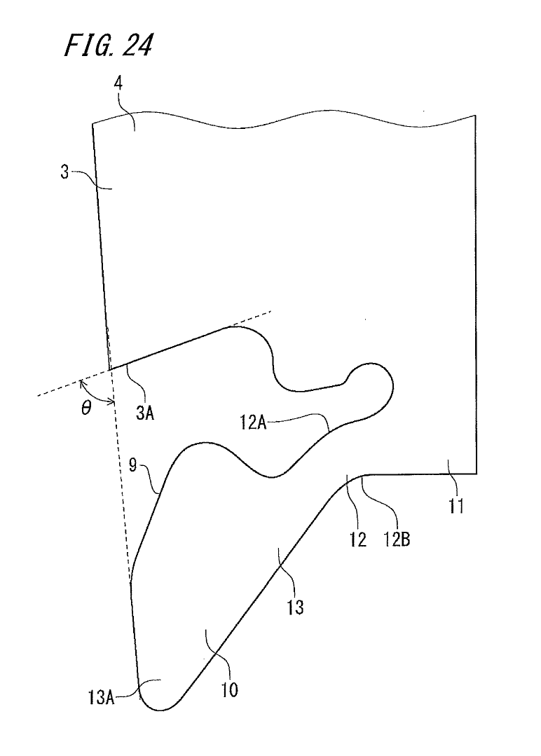

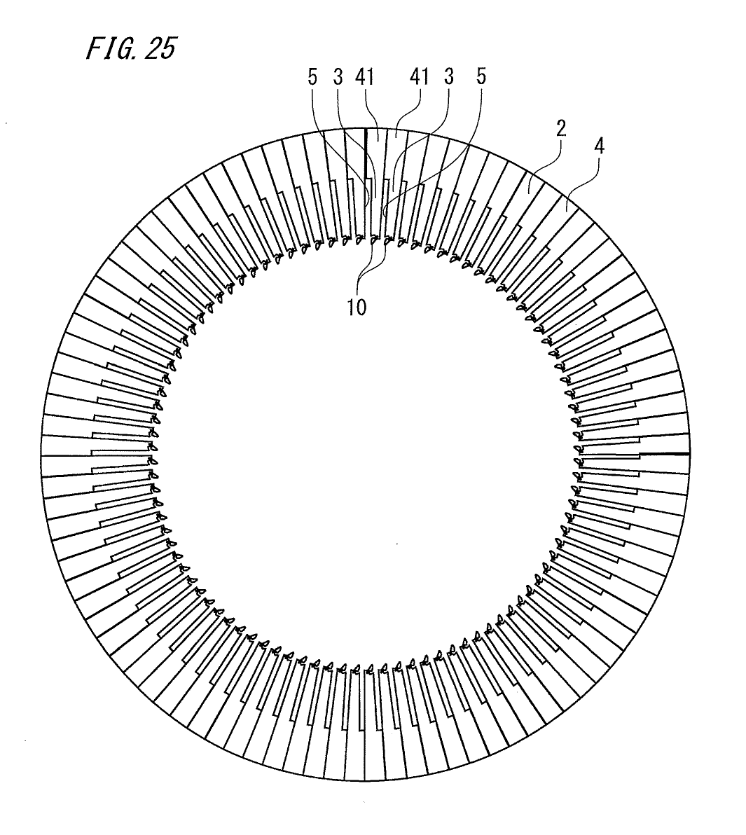

The example in which the stop portions 13 are formed at both sides in the circumferential direction Z of the tooth portion 3 has been described above in each embodiment. However, the present invention is not limited thereto, and the case where the stop portion 13 is formed at only one side in the circumferential direction Z of the tooth portion 3 will be described in Embodiment 4. FIG. 23 is a plan view showing the configuration of a core of a stator according to Embodiment 4 of the present invention. FIG. 24 is a plan view showing a state before the core of the stator shown in FIG. 23 is bent. FIG. 25 is a plan view showing the state before the core of the stator shown in FIG. 24 is bent. In the drawings, the same parts as in each embodiment described above are designated by the same reference characters, and the description thereof is omitted.

The stator of the rotary electric machine of Embodiment 4 configured as described above achieves the same advantageous effects as in each embodiment described above, as a matter of course. In addition, since the stop portion is formed at only one side in the circumferential direction of the tooth portion, the distance from the bent portion to the end of the collar portion can be increased as compared to the case where the stop portions are provided at both sides, so that the bending angle can be decreased. Therefore, the effect of reducing the distortion is achieved.

It is noted that, within the scope of the present invention, the above embodiments may be freely combined with each other, or each of the above embodiments may be modified or simplified as appropriate.

1. A stator for a rotary electric machine, comprising:
a core having an annular back yoke portion and a plurality of tooth portions spaced apart from each other at intervals in a circumferential direction of the back yoke portion and projecting in a radial direction; and
a coil mounted to a plurality of slots between the adjacent tooth portions via insulating portions, wherein
a collar portion is provided at an end portion at a projection side in the radial direction of each of the tooth portions so as to project to the slot side in the circumferential direction,
the collar portion includes
a connection portion connected to the tooth portion,
a bent portion extending from the connection portion in the circumferential direction and forming a first gap across which the bent portion is spaced apart from the end portion of the tooth portion, and
a stop portion extending from the bent portion in the circumferential direction, projecting at an end side thereof in the circumferential direction to the slot side, and having a width in the radial direction larger than a width in the radial direction of the bent portion, and
an R dimension of a side surface, in the circumferential direction and at a side opposite to the projection side of the tooth portion, of the bent portion is not less than the width in the radial direction of the bent portion.

2. The stator for the rotary electric machine according to claim 1, wherein the first gap has a width in the radial direction smaller than a width thereof in the circumferential direction.

3. The stator for the rotary electric machine according to claim 1, wherein the stop portion and the end portion of the tooth portion form a second gap.

4. The stator for the rotary electric machine according to claim 3, wherein the second gap has a width in the radial direction smaller than the width in the radial direction of the first gap.

5. The stator for the rotary electric machine according to claim 3, wherein a cushioning material is provided in the second gap.

6. The stator for the rotary electric machine according to claim 1, wherein the collar portion is formed at only one side in the circumferential direction of the tooth portion.

7. The stator for the rotary electric machine according to claim 1, wherein, in the bent portion, a width in the radial direction at the connection portion side and a width in the radial direction at the stop portion side are equal to each other.

8. The stator for the rotary electric machine according to claim 7, wherein the bent portion has a recess on a circumferential side surface at the projection side of the tooth portion.

9. The stator for the rotary electric machine according to claim 1, wherein, in the bent portion, a width in the radial direction at the connection portion side is larger than a width in the radial direction at the stop portion side.

10. The stator for the rotary electric machine according to claim 1, wherein
the core is formed by stacking a plurality of sheets in an axial direction, and
the width in the radial direction of the bent portion is not less than a sheet thickness of each sheet.

11. The stator for the rotary electric machine according to claim 1, wherein
the core is formed by stacking the plurality of sheets in the axial direction, and
the sheets are formed of electromagnetic steel sheets containing silicon.

12. The stator for the rotary electric machine according to claim 1, wherein
the core is formed of a plurality of divided cores divided in the circumferential direction, and
each of the divided cores is formed of a member having an allowable elongation in the circumferential direction larger than an allowable elongation thereof in the radial direction.

13. A rotary electric machine comprising:
the stator for the rotary electric machine according to claim 1; and
a rotor disposed so as to be concentric with the stator.

14. A method for manufacturing the stator for the rotary electric machine according to claim 1, the method comprising:
a first step of forming the core in a state where the collar portions do not project to the slot side in the circumferential direction;
a second step of mounting the coil to the slots of the core via the insulating portions; and
a third step of bending the collar portions in the circumferential direction to project the collar portions to the slot side.

15. The stator for the rotary electric machine according to claim 2, wherein the stop portion and the end portion of the tooth portion form a second gap.

16. The stator for the rotary electric machine according to claim 4, wherein a cushioning material is provided in the second gap.

17. The stator for the rotary electric machine according to claim 2, wherein the collar portion is formed at only one side in the circumferential direction of the tooth portion.

18. The stator for the rotary electric machine according to claim 2, wherein, in the bent portion, a width in the radial direction at the connection portion side and a width in the radial direction at the stop portion side are equal to each other.

19. The stator for the rotary electric machine according to claim 2, wherein, in the bent portion, a width in the radial direction at the connection portion side is larger than a width in the radial direction at the stop portion side.

20. The stator for the rotary electric machine according to claim 2, wherein
the core is formed by stacking a plurality of sheets in an axial direction, and
the width in the radial direction of the bent portion is not less than a sheet thickness of each sheet.
